(19) United States
(12) Patent Application Publication
(10) Pub. No.: US 2025/0331459 A1
(43) Pub. Date: Oct. 30, 2025

(54) APPARATUSES SYSTEMS AND METHODS FOR AGRICULTURAL MACHINE HEADER FORE-AFT MOTION

(71) Applicant: DEERE & COMPANY, MOLINE, IL (US)

(72) Inventors: JUSTIN C. FREEHILL, Fenton, IL (US); JOSHUA R. PIERSON, Bettendorf, IA (US); Cristiano Engelmann, Horizontina (BR); DUANE M. BOMLENY, Geneseo, IL (US); ALEX A. BRIMEYER, Bettendorf, IA (US); NATHAN E. KREHBIEL, Bettendorf, IA (US)

(21) Appl. No.: 18/650,686

(22) Filed: Apr. 30, 2024

(51) Int. Cl. A01D 57/04; A01D 41/06; A01D 69/02; A01D 69/03

(52) U.S. Cl. CPC A01D 57/04; A01D 41/06; A01D 69/02; A01D 69/03

(57) ABSTRACT

Example apparatuses systems and methods are provided herein. In some examples a work machine header reel adjustment system includes a central frame. The system includes a plurality of elongated reel supports extending from the central frame. The system includes a plurality of reel mounts movably coupled to the reel supports. The system includes a translation assembly extending from the central frame to the reel mounts. The system includes one or more actuators coupled to the translation assembly. The one or more actuators are configured to move the reel mounts longitudinally along the plurality of reel supports through the translation assembly. Each of the one or more actuators are configured to move a plurality of the reel mounts.

### FIELD OF THE DISCLOSURE

This disclosure generally relates to agricultural work machines, and more specifically to header positioning assemblies and methods of operating header positioning assemblies.

### BACKGROUND OF THE DISCLOSURE

Various agriculture work vehicles perform a wide variety of agricultural operations such as, for example, combines and windrowers harvesting a variety of different crops. Depending on the crop or other factors, headers used to harvest the crop may have significantly different geometries, weights, and forward travel speed requirements. Examples of header platforms may include a rotary mower conditioner and a draper.

### SUMMARY OF THE DISCLOSURE

Example apparatuses systems and methods are provided herein. In some examples a work machine header reel adjustment system includes a central frame. The system includes a plurality of elongated reel supports extending from the central frame. The system includes a plurality of reel mounts movably coupled to the reel supports. The system includes a translation assembly extending from the central frame to the reel mounts. The system includes one or more actuators coupled to the translation assembly. The one or more actuators are configured to move the reel mounts longitudinally along the plurality of reel supports through the translation assembly. Each of the one or more actuators are configured to move a plurality of the reel mounts.

In some examples a method of moving a header in a fore-aft motion includes receiving fore-aft movement instructions, based at least in part on a determined reel location and a desired reel location. The method includes activating one or more actuators coupled to a plurality of reel mounts through a translation assembly. The one or more actuators is configured to move the reel mounts longitudinally along a plurality of reel supports. The number of one or more actuators is less than the number of reel mounts.

### BRIEF DESCRIPTION OF THE DRAWINGS

The detailed description of the drawings refers to the accompanying figures in which:

FIG. 1A is a side view of an exemplary agricultural vehicle.

FIG. 1B is a top view of a front portion of the agricultural vehicle shown in FIG. 1.

FIG. 2 is a top view of an example combine header.

FIG. 3 is a perspective view of an example center section of the combine header shown in FIG. 2.

FIG. 4 is a perspective view of a portion the center section of the combine header shown in FIG. 3.

FIG. 5 is a cutaway perspective view of a portion the center section of the combine header shown in FIG. 4.

FIG. 6 is a perspective view of an alternative configuration of a center section of the combine header shown in FIG. 2.

FIG. 7 is a flow chart of example steps for operating the combine header shown in FIG. 2.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Words of orientation, such as “up,” “down,” “top,” “bottom,” “above,” “below,” “leading,” “trailing,” “front,” “back,” “forward,” and “rearward,” used in the context of the provided examples would be understood by one skilled in the art and are not intended to be limiting to the disclosure. For example, for a particular type of vehicle in a conventional configuration and orientation and being operated in a conventional manner, one skilled in the art would understand these terms in the context in which they are used and as those terms apply to a particular vehicle. For example, one skilled in the art would appreciate what the forward direction is in the context of a direction that a combine harvester normally moves when actively harvesting crop during a crop harvesting operation. Further, one skilled in the art would appreciate what the reverse direction would be for the agricultural harvester during normal operation of the agricultural harvester.

Additionally, the term “forward” (and the like) corresponds to a forward direction of travel of a work machine (e.g., header or combine harvester), such as during a harvesting operation. Likewise, the term “rearward” or “reverse” (and the like) corresponds to a direction opposite the forward direction of travel. In this regard, for example, a “forward facing” feature on a header may generally face in the direction that the head travels during normal operation, while a “rearward facing” feature may generally face opposite that direction.

Also as used herein, with respect to a work machine, unless otherwise defined or limited, the term “leading” (and the like) indicates a direction of travel of the work machine during normal operation (e.g., the forward direction of travel of a harvester vehicle carrying a header). Similarly, the term “trailing” (and the like) indicates a direction that is opposite the leading direction. In this regard, for example, a “leading” edge of a header may be generally disposed at the front of the header, with respect to the direction travel of the header during normal operation (e.g., as carried by a combine harvester). Likewise, a “trailing” edge of a header may be generally disposed at the back of the header opposite the leading edge, with respect to the direction of travel of the header during normal operation.

Although the present disclosure is made in the context of agricultural harvesters (e.g., combine harvesters), the scope of the present disclosure is not so limited. Rather, the scope of the disclosure encompasses work machines in numerous other industries in which rearward visibility from an operator's station of the vehicle is obstructed or otherwise unavailable.

Some harvesters utilize combine headers that have multiple actuators to control fore-aft movement. Combine headers typically utilize a plurality of actuators to translate a plurality of header sections in a fore-aft direction with respect to a chassis of the agricultural work machine. The actuators are often hydraulic actuators that utilize a single fluid source in series with the plurality of actuators, which can introduce inefficiencies. As such, traditional actuator systems for fore-aft motion of a header can cause the actuators to mistime with respect to each other or provide uneven force. Such mistiming and uneven force distribution can cause the sections of a header to be disposed unevenly causing mechanical complications or inefficient harvesting. Disclosed herein are apparatuses systems and methods for moving a plurality of header mounts using an actuator and a mechanical translation assembly. The single actuator and translation assembly are configured to provide substantially uniform force and synchronized timing for fore-aft movement for a plurality of header sections, which may provide efficient and sustainable operation.

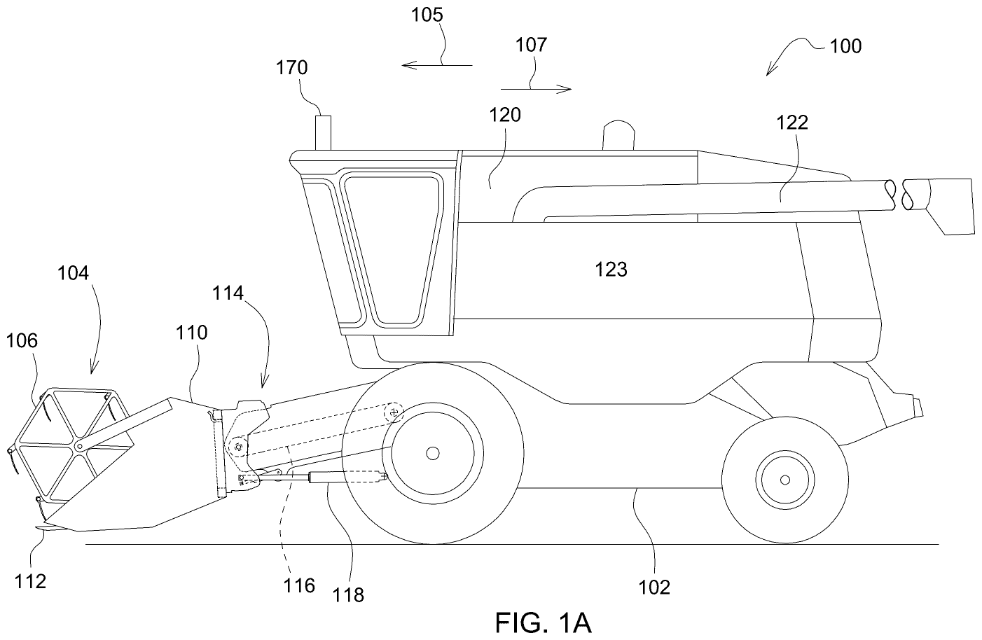

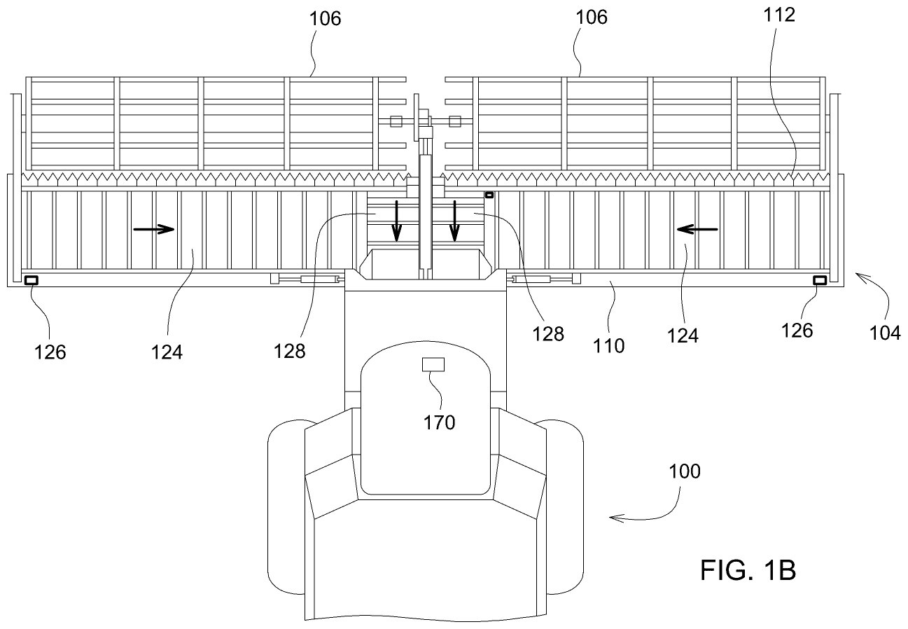

FIGS. 1A-1B illustrates a side view of an agricultural vehicle 100 in the form of a combine harvester that is coupled to a header 104. While FIGS. 1A-1B illustrate a particular example of an agricultural vehicle 100, a variety of other types of agricultural machines and vehicles may be utilized as the agricultural vehicle 100, including, but not limited to, forge harvesters and windrowers, among others. Further, the illustrated agricultural vehicle 100 may be movable, among other directions, in both the forward direction and the rearward direction, as indicated by arrows 105, 107, respectively, shown in FIGS. 1A-1B. Thus, the agricultural vehicle may move forwardly as the agricultural vehicle 100 is harvesting crop material. as well as moveable rearwardly to be selectively movable out of, or away from, crop material.

Although not shown in FIGS. 1A-1B, it should be appreciated that the agricultural vehicle 100 at least partially houses a number of devices and/or systems in an interior thereof, such as one or more threshing device(s), separating device(s), and cleaning device(s), for example. Further, the agricultural vehicle 100 at least partially defines a tank 120 that may be used to store cleaned crop materials (e.g., grain) prior to removal and unloading onto a transport vehicle by an unloading conveyor 122.

The agricultural vehicle 100 depicted in FIG. 1 is shown as having an exemplary header 104 in the form of a draper belt header. However, the agricultural vehicle 100 may have a variety of other types of headers 104, including, but not limited to, corn headers. The exemplary header 104 is coupled to a chassis 102 and positioned to remove crop material from the ground during use of the agricultural vehicle 100. Moreover, the illustrated header 104 includes a reel 106 to draw crop material that is cut by a cutter bar 112 of the header into the header 104. As discussed below, the reel 106 is selectively movable relative to a frame or bearing frame 110 of the header 104, including during use of the agricultural vehicle 100.

The header 104 may also be moveable relative to the ground surface to adjust a vertical height of the header, also referred to as header height. For example, according to certain examples, the header 104 is pivotable by an actuator 118 relative to the chassis 102 about an axis which extends horizontally and transversely to the forward direction indicated by arrow 105. In some examples, the axis may coincide with a rotational axis of an upper guide roller of the central belt conveyor 116 of the header 104 to be able to modify the height of the header 104 above the ground.

The header 104 is configured to direct cut crop material to a feederhouse 114. Moreover, the header 104 may include one or more conveyors or augers, as well as a combination thereof, to convey crop material, and, more particularly cut crop material, along the header 104 and to the feederhouse 114. For example, the exemplary header 104 shown in at least FIGS. 1A-1B include two outer belt conveyors 124 that are each connected to a driver 126 that provides power for the rotational displacement of the drives outer belt conveyors 124. Accordingly, during harvesting of crop material, the power provide by the driver 126 may be transmitted to the each of the two outer belt conveyors 124 such that the top sides of the belts of the outer belt conveyors 124 move inwardly (i.e., as shown by the arrows) so as to convey crop material captured by the reel 106 and severed by the cutter bar 112 to the center of the header 104. Crop material conveyed to the center of the header 104 is then conveyed on a belt of the central belt conveyor 116 that is driven by a driver 128 and transported rearwardly into the feederhouse 114.

In at least certain circumstances, the position of the header 104 or the reel 106 may be adjusted to accommodate for variances in either, or both, the elevation of the associated terrain or attributes, including characteristics or properties, of the crop material, such as, for example, the height of the crop or crop posture. Moreover, regardless of the type of header 104 utilized, in at least efforts to improve the efficiency in the operation of the header 104, and corresponding crop yield, the header 104, or associated components thereof, is/are often at a select position(s) relative to either, or both, the adjacent ground surface or an attribute of the crop material, including, for example, crop height. However, the elevation of the ground surface, or associated crop attribute, as well as soil types, moisture levels, and nutrients, among other characteristics, may vary across a field, which may, if not properly addressed, adversely impact the crop yield gathered via operation of the header. In some examples, the header 104, the reel 106 may be displaced relative to a frame 110 of the header 104 via operation of one or more actuators. A variety of different types of devices, as well as combinations of devices, may be utilized for the actuators, including, for example, electrically driven linear actuators, a pneumatic actuator, or another hydraulically operated actuators, as well as combinations thereof, among other devices. Thus, for example, one or more of the actuators may be a double-acting hydraulic or pneumatic cylinder that is extendable and retractable to vary a length thereof. Such actuators may thus further include one or more associated pumps, motors, or control valves, as well as various combinations thereof, among other devices, that are utilized in controlling the selective extension and retraction of such cylinders. In some examples, the number of actuators may vary.

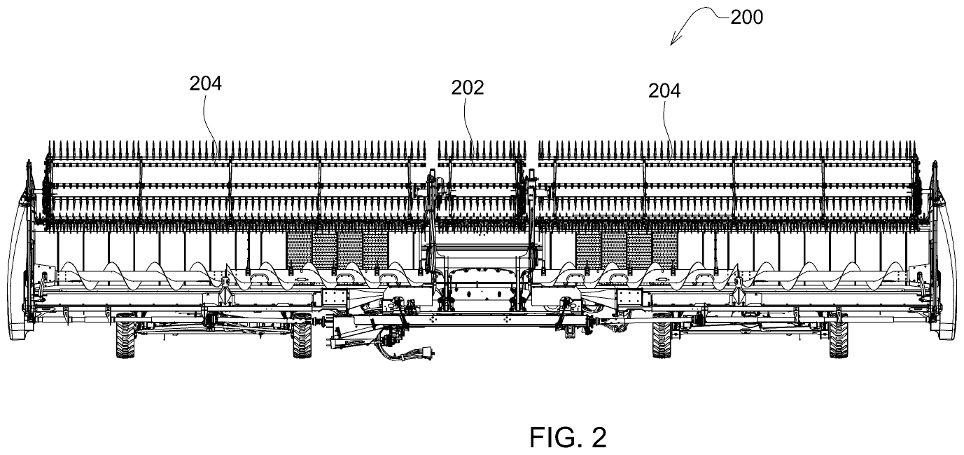

As shown in FIG. 2, in some examples, a header 200 may include a center section 202 and one or more wing sections 204. The wing sections 204 may be coupled to either side of the center section 202. In some examples, a plurality of center sections 202 and wing sections 204 may be coupled in series.

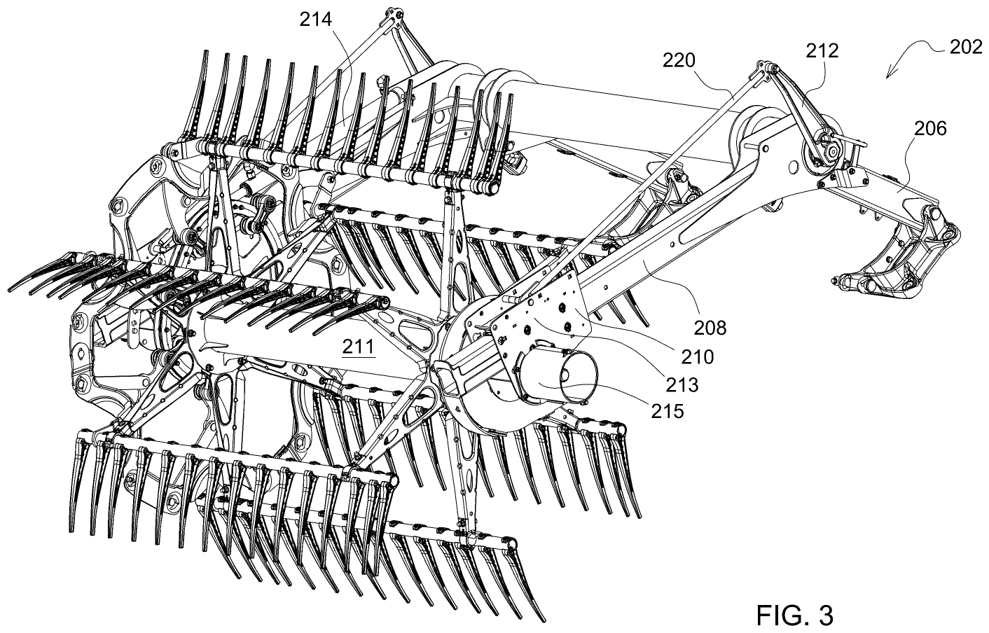

In the example shown in FIG. 3, the center section 202 includes a central frame 206 the two reel supports 208, two reel mounts 210 slidably coupled to the reel supports 208, a translation assembly 212, and an actuator 214 coupled to the translation assembly 212. The central frame 206 is configured to be narrower than wing sections 204 of the header 200. In some examples, the central frame 206 is a width configured to fit a desired cumulative width of the side portions within the header 200.

As shown in FIG. 3, the central frame 206 may include a plurality of reel supports. The reel supports 208 are substantially rigid bars disposed on the central frame 206 and which extend in a longitudinal direction with respect to forward and backward operational directions of the work machine 100 and header 200. The reel supports are configured to prevent the reel mounts 210 from sliding beyond the reel supports 208 in a fore direction. The reel supports 208 may be rigid supports configured to rigidly constrain a portion of reel mounts 210 to move in a fore-aft direction. The reel supports 208 may be formed from suitable rigid materials for a work machine application. For example, in some examples, the reel supports 208 such as, aluminum, composite, or steel.

As shown in FIG. 3, the reel mounts 210 may be slidable mounts configured to receive a combine reel rotating assembly 211. The reel mounts 210 each include a frame 213 that defines a channel to receive the reel frame. The reel mounts 210 also include a reel receiver 215 configured to receive a rotating assembly 211 such that the rotating assembly 211 may freely rotate about the reel receiver 215. The reel mounts 210 are disposed about the reel mount frame 213 opposite and spaced apart from each other such that that the reel mounts 210 may be parallel each other at a given time during operation of the work machine 100. The reel mounts 210 may be slidably coupled to the reel supports 208 such that the reel mounts 210 may move substantially freely axially along the reel supports 208 in a fore-aft direction as directed by the translation assembly 212. In other examples, the reel mounts 210 may be rollably coupled to the reel supports 108 such that the reel mounts 210 roll along at least one surface of the reel mounts 210 using a suitable rollable mechanism. For example, the reel mounts 210 may roll along the reel supports 208 using one or more roller wheels or one or more bearings. The reel mounts 210 may be formed from suitable rigid materials to retain the combine rotating assembly 211 during operation. For example, in some examples, the reel mounts 210 may be made from materials such as, aluminum or steel.

As shown in FIG. 3, the translation assembly 212 is configured to cause movement of a portion of the header 200 such as the rotating assembly 211 in a fore-aft direction. The translation assembly 212 is further configured to provide movement to the first support and the second support using one actuator 214 to move a plurality of reel mounts. The translation assembly 212 includes the connection linkage 220 to translate movement from the actuator 114 to a plurality of mounts, such as the reel mounts 210. The connection linkages 220 transfer energy and provide a desired energy expenditure and motion from the actuator 214 to the reel mounts 210.

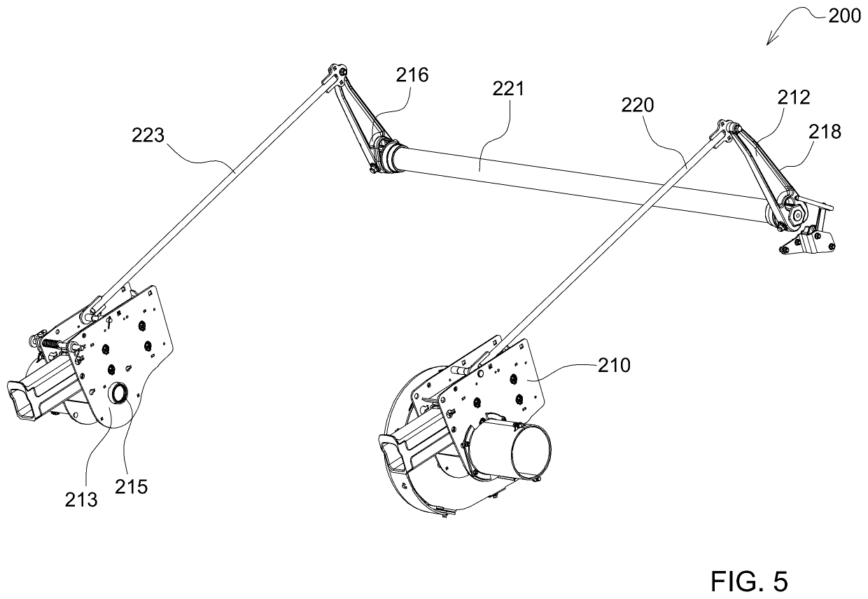

The translation assembly 212 includes a rotator assembly 216, a first arm and a second arm 218 and a uniform drive rod 221 (shown in FIG. 5) extending between the first arm and the second arm 218 such that movement of the drive rod causes substantially uniform movement of each of the first arm and the second arm. The first arm and the second arm 118 are each coupled to the rotator assembly 216 via a connection linkage 220 which directs the motion of the reel mounts 210 along the reel supports 208. As such, the rotator assembly 216 is movably connected to the actuator 214 through the arms 218 such that linear movement of an actuator 214 causes rotational movement of the rotator assembly 216, which further moves the arms 218 in a linear motion.

In the example shown in FIG. 3, the rotator assembly 216 of the translation assembly 212 is a mechanical system that includes a rotator arm, and is coupled to the actuator 114. The rotator is configured to be a rotating element with an irregular shape, which includes a rotator profile suitable for fore-aft movement in a desired frequency and magnitude. As such, the shape of the rotator is configured to control the motion of the arms in a desired fore-aft direction. The arms 218 function as a follower in the rotator assembly 216. One end of each of the arms 218 is rotatably coupled to the cam's surface and move the reel mounts 210 based on the rotator profile. As such, the translation assembly 212 may be configured to provide a desired ratio of rotational motion and linear motion for a specific combine application to provide desired efficiency between the actuator 214 and rotating assembly 211.

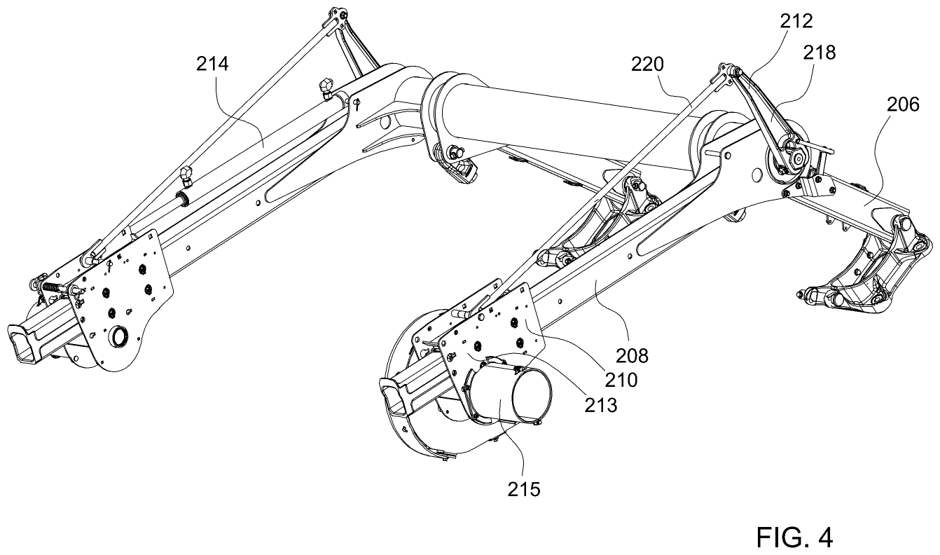

FIG. 3 shows the actuator 214. The actuator 214 is configured to provide translation force to the rotating assembly 211 to move the rotating assembly 211 in a desired direction. In the example shown in FIGS. 3-4, the actuator 214 is configured to move the rotating assembly 211 in the fore-aft direction. In some examples, the actuator 214 may be a configured to provide force to move a header 200 assembly during, before, or after combine operation. For example, the actuator 214 may be a linear actuator or a rotary actuator configured to move at least a portion of the header 200 in the fore-aft direction while resisting objects that may oppose fore-aft movement. For example, the actuator 214 may be configured to move the rotating assembly 211 through crops such as corn.

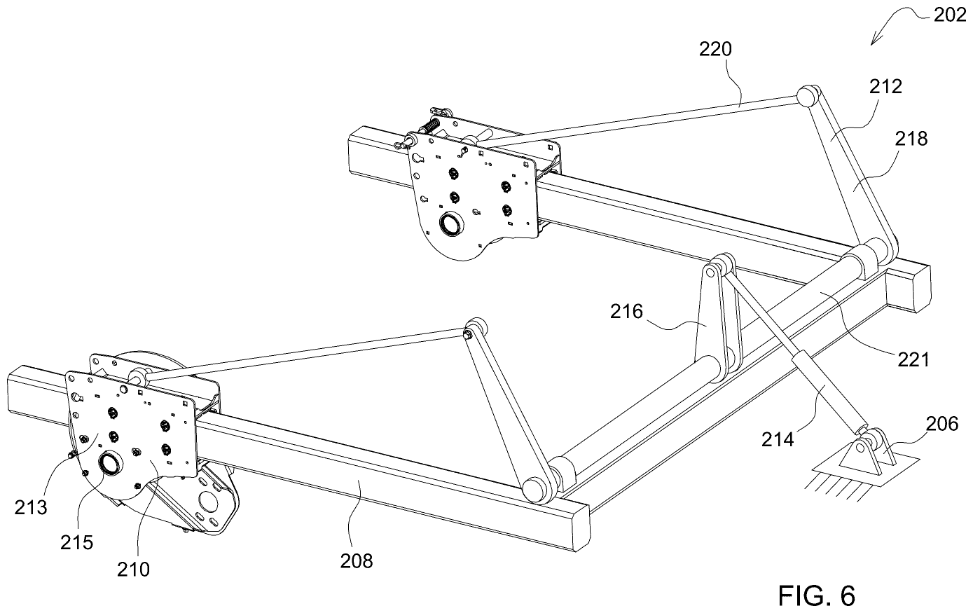

The actuator 214 may be a hydraulic actuator 214. The actuator 114 may be coupled to the rotator in a plurality of locations based on the configuration of the header 200 for desired combine operation. For example, as shown in FIGS. 3-4, the actuator 214 may be coupled to one of the reel supports 208 such that the actuator 214 is disposed about one of the sides of the center section 202. In some examples, the actuator may be disposed in various locations of the header 200. For example, as shown in FIG. 6 the actuator 214 may be disposed about the center of the center section 202.

In examples including a hydraulic actuator, the actuator 214 is configured to convert hydraulic fluid pressure from a fluid system in the work machine into fore-aft mechanical motion though the translation assembly 212. The hydraulic actuator may utilize hydraulic fluid within other portions of the combine system or a separate fluid reservoir to provide desired pressure. As such, the pressurized fluid is used to transmit power through the header 200. In some examples, the hydraulic system of the hydraulic actuator may include an electronic pressure controller such that the hydraulic actuator may be controlled and/or modulated based on instructions from an electronic controller.

In some examples, the actuator 214 may be an electronic actuator. For example, the electronic actuator may be configured to adjust a position of the header utilizing an electrical power source. In some examples, the actuator 214 may provide controlled and/or modulated movement for the header 200 based on instructions from an electronic controller. In some examples, the electronic actuator may be a linear actuator (screw or belt-driven) or a rotary actuator (motor), which may receive power from a power source of the agricultural machine 100 or a separate power source. In some examples, the electronic actuator may include a motor (such as a stepper motor, servo motor, or DC motor), a mechanical transmission system (such as a lead screw, ball screw, or belt drive), and a control system (such as a microcontroller or a dedicated driver). In examples including a linear actuator, the motor's rotational motion may be converted into linear motion through the mechanical transmission system, which is transferred to the cam of the translation assembly 212.

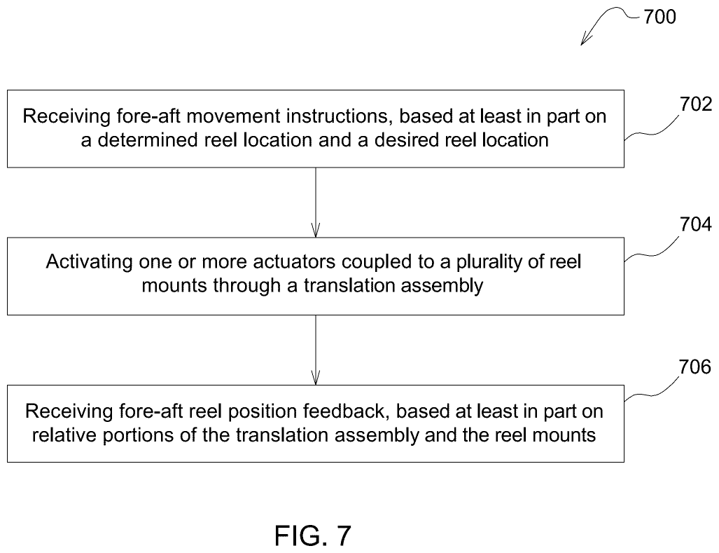

In some examples, the work machine 100 includes a central controller 123. The central controller 123 may be configured to provide instructions and manage processes for the work machine. The central controller 123 may control the actuator 214. For example, the central controller 123 may provide electronic signals to a hydraulic actuator with an electronic valve or an electronic actuator. As such, the central controller 123 may transmit instructions to the actuator 214 to provide desired fore-aft movement instructions for a combine operation. FIG. 7 shows example steps for a method of moving a header in a fore-aft motion.

In the step 702 in the example shown in FIG. 7, the central controller 123 may receive fore-aft movement instructions from an operator. The fore-aft movement instructions may be based at least in part on a determined reel location and a desired reel location. The determined reel location may be a detected reel location at a given time. The desired reel location may be an extended or retracted position of the rotating assembly 211 in the fore-aft directions based on a determination from an operator or processor. For example, the central controller 123 may determine a location of the header with respect to an agricultural work machine at a given time and a desired location of the header with respect to the agricultural machine based on the requirements of a future combine operation.

In the step 704 in the example shown in FIG. 7, the central controller 123 may provide instructions to activate one or more of the one or more actuators 214 coupled to the plurality of reel mounts 210 through the translation assembly 212. In some examples where the actuator is a hydraulic actuator, the controller 123 may be configured to determine and/or transmit instructions to the actuator 214 for a desired actuator pressure of the hydraulic fluid and the effective area or geometry of the piston or rotor. In examples including an electronic actuator, the central controller 123 may transmit instructions to transmit a desired amount of electrical power to the actuator 214. In some examples, the instructions may be determined based on a combine operation application. For example, the instructions may be dynamically adjusted during a combine operation based on desired harvesting parameters and/or dynamic field conditions.

In some examples, the central controller 123 may be configured to move the actuator 214 with a desired power based at least on the header specifications such as weight and size. In some examples, the instructions may be to move the actuator 214 based on a desired distance and angle of movement with respect to a ground surface and/or the work machine 100. The central controller 123 may further determine a desired movement force based at least in part on the characteristics of the translation assembly 212. For example, the translation assembly 212 may distribute force from the actuator 214 in a desired direction among a plurality of reel mounts 210. As such, the central controller 123 may determine the desired force based at least in part on distribution of force through the translation assembly 212.

In the step 706 in the example shown in FIG. 7, the central controller 123 may receive feedback from one or more sensors of the work machine providing fore-aft reel position feedback such as position with respect to a ground surface and/or the work machine. In some examples, the feedback may be based at least in part on relative portions of the translation assembly 212 and the reel mounts 210 such that the central controller 123 may provide further control instructions based at least in part on the feedback and a desired position of the header. In some examples, the sensors may be one or more cameras, RFID sensors, or other suitable sensors for determining the location of portions of a work machine with respect to each other.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

1. A work machine header reel adjustment system comprising:
a central frame;
a plurality of elongated reel supports extending from the central frame;
a plurality of reel mounts movably coupled to the reel supports;
a translation assembly extending from the central frame to the reel mounts; and
one or more actuators coupled to the translation assembly,
wherein the one or more actuators is configured to move the reel mounts longitudinally along the plurality of reel supports through the translation assembly, and
wherein, each of the one or more actuators is configured to move a plurality of the reel mounts.

2. The system of claim 1, wherein the plurality of reel mounts is coupled to the reel supports such that the reel mounts are each movable in a direction substantially parallel to a direction of movement of the central frame during a harvesting operation.

3. The system of claim 1, wherein the one or more actuators is a hydraulic actuator.

4. The system of claim 1, wherein the one or more actuators is an electrical actuator.

5. The system of claim 1, wherein the translation assembly comprises a rotator assembly having an actuator end and a mounting end,
wherein the actuator end is coupled to an actuator of the one or more actuators, and
wherein the mounting end is coupled to the plurality of reel mounts.

6. The system of claim 1, wherein the translation assembly comprises a uniform drive rod coupled to the reel mounts, such that movement of the drive rod causes substantially uniform movement of each of the reel mounts.

7. The system of claim 1, wherein the actuator is configured to translate the reel mounts in a fore-aft motion with respect to the header.

8. An adjustable work machine header that is movable between a plurality of configurations, the header comprising:
a plurality of header sections, wherein one or more of the sections comprises:
a central frame,
a plurality of elongated reel supports extending from the central frame;
a plurality of reel mounts movably coupled to the reel supports;
a translation assembly extending from the central frame to the reel mounts, and
one or more actuators coupled to the translation assembly,
wherein the actuator is configured to move the reel mounts longitudinally along the plurality of reel supports through the translation assembly, and
wherein, each of the one or more actuators is configured to move a plurality of the reel mounts.

9. The header of claim 8, wherein the plurality of reel mounts is movable in a forward direction and a backward direction with respect to the work machine.

10. The header of claim 8, wherein the one or more actuators is a hydraulic actuator in hydraulic communication with one or more other components of the header.

11. The header of claim 8, wherein the one or more actuators is an electrical in electrical communication with one or more other components of the header.

12. The header of claim 8, wherein the translation assembly comprises a rotator assembly having an actuator end and a mounting end, and
wherein the actuator end is coupled to an actuator of the one or more actuators, and
wherein the mounting end is coupled to the plurality of reel mounts.

13. The header of claim 8, wherein the translation assembly comprises a uniform drive rod coupled to the reel mounts, such that movement of the drive rod causes substantially uniform movement of each of the mounts.

14. The header of claim 8, wherein the header includes three sections, wherein a position of each of the three sections is adjustable with respect to each other.

15. The header of claim 14, wherein the three sections include a center section which includes the central frame.

16. The header of claim 15, wherein the center section is smaller than the other sections of the header.

17. The header of claim 8, wherein the actuator is configured to translate the reel mounts in a fore-aft motion with respect to the header.

18. A method of moving a header in a fore-aft motion comprising:
receiving fore-aft movement instructions, based at least in part on a determined reel location and a desired reel location;
activating one or more actuators coupled to a plurality of reel mounts through a translation assembly,
wherein the one or more actuators is configured to move the reel mounts longitudinally along a plurality of reel supports, and
wherein, the number of one or more actuators is less than the number of reel mounts.

19. The method of claim 18, further comprising receiving fore-aft reel position feedback, based at least in part on relative portions of the translation assembly and the reel mounts.

20. The method of claim 18 further comprising activating the one or more actuators based at least in part on the fore-aft reel position feedback.
